(19) United States
(12) Patent Application Publication
(10) Pub. No.: US 2008/0215196 A1
(43) Pub. Date: Sep. 4, 2008

(54) METHOD AND SYSTEM USED BY AN AIRCRAFT TO FOLLOW A DESCENT TRAJECTORY MATCHED WITH A TIME SCHEDULE

(75) Inventor: Guy Deker, Cugnaux (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly-Sur-Seine (FR)

(21) Appl. No.: 11/937,995

(22) Filed: Nov. 9, 2007

(30) Foreign Application Priority Data
Nov. 10, 2006 (FR) 06 09845

(51) Int. Cl. G05D 1/08

(52) U.S. Cl. 701/5

(57) ABSTRACT

The present invention relates to a method and a system used by an aircraft to follow a descent trajectory matched with a time schedule. The method is characterized in that the speed of the aircraft is servo-controlled to the speed required to comply with the time schedule by adjusting the pitch angle when the aircraft is not below the planned altitude on the trajectory beyond a threshold and by adjusting the engine thrust when the aircraft is below the planned altitude on the trajectory beyond the threshold.

### RELATED APPLICATIONS

The present application is based on, and claims priority from, France Application Number 06 09845, filed Nov. 10, 2006, the disclosure of which is hereby incorporated by reference herein in its entirety.

### FIELD OF THE INVENTION

The present invention relates to a method and a system used by an aircraft to follow a descent trajectory. It applies in particular to the avionics field.

A flight plan is a detailed description of the trajectory to be followed by an aircraft in the context of a flight planned in advance. In particular it comprises a route, that is a chronological sequence of waypoints described by their position, altitude and overflight time. The waypoints are followed by the aircraft if the latter complies perfectly with its flight plan, which thereby forms a precious aid both to the air flight traffic control personnel on the ground and to the flight personnel on board in order to anticipate the movements of the aircraft and ensure an optimum safety level. The flight plan is routinely managed on board aircraft by a system called the “Flight Management System”, that will hereinafter be called FMS, which places the flight plan at the disposal of the other onboard systems. In particular the automatic pilot system uses guidance instructions generated from the flight plan made available by the FMS system. Therefore it can direct the aircraft throughout the flight, whether to assist the pilot or replace him. In the descent phase for landing, two parameters of the vertical profile of the aircraft need to be controlled tightly: altitude and speed.

On board an aircraft, the altitude results from a balance between the angle of inclination of the elevator and the acceleration given by the engine thrust. Specifically, the angle of inclination of the elevator also determines the angle of inclination of the aircraft about its horizontal transverse axis. In avionics, this axis is called the pitch axis and the inclination about this axis is called the pitch angle. By pushing the control column forward, the nose of the aircraft goes down and the aircraft descends following its longitudinal axis now inclined downwards. By pulling the control column rearwards, the nose of the aircraft goes up and the aircraft climbs following its longitudinal axis now inclined upwards. As for the speed of the aircraft, it is essentially dependent on the engine thrust and the configuration of the aircraft in terms of leading edge slats, flaps and elevator. By squeezing the throttle, the engine thrust increases and the aircraft accelerates along its longitudinal axis while increasing its angle of attack which would have a tendency to cause the aircraft to climb if it were not balanced accordingly at the elevator. By releasing the throttle, the engine thrust reduces and the aircraft slows down along its longitudinal axis while lowering its angle of attack, which causes it to descend.

Therefore in reality, the altitude and speed of an aircraft are closely linked and it is not possible to adjust one of the two parameters without disrupting the other. Specifically, at constant thrust, when the aircraft is inclined by acting on the control column, it is made not only to climb or descend, but it is also made to slow down or accelerate, even if this occurs with a slight delay. In the same manner, with a fixed elevator, when the engine thrust is adjusted by acting on the throttle, the aircraft is made not only to slow down or accelerate, but it is also made to descend or climb, again with a slight delay. Therefore, to ensure the closest possible following of the vertical profile of the flight plan, it is necessary to anticipate and compensate for the effects of one on the other. This is why the guidance instructions aiming to follow the vertical profile must be given so that the value of inclination about the pitch axis takes account of the value of thrust, and vice versa.

For example, on commercial aircraft of the Airbus type, a fairly complex operational logic of descent guidance is applied. This logic aims not only to solve the technical problem posed by the dependence between the engine thrust and the angle of inclination of the elevator, but it also aims to satisfy other constraints of an economic nature. First of all it involves minimizing the consumption of kerosene, by, for example, using the engines as much as possible at their optimum climbing, cruising and descent rates. It also involves complying with the air traffic management procedures as closely as possible, particularly in terms of time schedule, by keeping the aircraft in a “4D tube” centred on the flight profile. Finally it involves limiting the variations of thrust in order to minimize wear of the engines and promote the comfort of the passengers. However, these economic constraints are difficult to reconcile and are even contradictory. For example, seeking to keep the engines at their cruising rate is necessarily achieved to the detriment of complying with the air traffic management procedures. At cruising rate, neither the recommended speeds nor altitudes can be maintained, consequently the aircraft cannot follow the “4D tubes” extremely closely. Therefore, the comfort of the passengers and the husbanding of the engines appear antagonistic to following the air traffic management procedures. In fact, these economic constraints cannot be satisfied simultaneously: some of them have to be chosen to the detriment of the others. The existing systems have developed complex logics that are based on different “guidance modes”, each guidance mode being most particularly adapted to two constraints that it considers to have priority. Unfortunately, these systems are operational at the price of frequent changes of guidance modes and even of guidance submodes.

Each guidance mode is characterized by a pair of guidance instructions that make it possible to fix two flight parameters. The instructions in question are four in number. The thrust instruction for aircraft fitted with turbojet engines or rate instruction for turboprops, commonly called the THR instruction, makes it possible to fix the parameter of engine thrust at a given rate. The pitch instruction, commonly called the “Vpath” for “vertical path”, makes it possible to fix the parameter of inclination of the aircraft about its pitch axis. The speed instruction, commonly called the SPD instruction, makes it possible to fix in knots the speed parameter of the aircraft along the horizontal component. Hereinafter, the speed horizontal component will simply be called “speed”. Finally, the vertical speed instruction, commonly called the VS instruction, makes it possible to fix in feet per minute the speed of vertical descent. Therefore, in each guidance mode, two of the four flight parameters are servo-controlled and the others are variable. In the mode called “Vpath/THR”, the slope of the vertical profile and the thrust are fixed. The slope of the vertical profile is controlled by the pitch angle. In the mode called “SPD/THR”, the speed and the thrust are fixed. In the mode called “Vpath/SPD”, the slope of the vertical profile and the speed are fixed. In the mode called “VS/SPD”, the vertical speed and the horizontal speed are fixed.

For example, in the nominal case corresponding to the highest portions at the beginning of descent, the aircraft begins its descent with no imposed slope. It is then necessary mainly to monitor the speed of the aircraft, not only for reasons of safety, excessive speed being one of the main risks in aviation, but also in order to observe the constraints of the flight plan in terms of speed and time.

Paradoxically, it is the Vpath/THR mode that is favoured at the beginning of descent, that is to say a mode in which the speed parameters are not fixed but in which the aircraft is servo-controlled to a speed and a profile calculated with this speed and a reduced thrust rate. Ideally, so long as there is no altitude constraint inducing fixed slopes, the best control parameters are the thrust fixed at the beginning of the descent at full reduced descent rate and the speed that remains under control by successive adjustments of the inclination about the pitch axis: the aircraft accelerates when its inclination is increased and it slows down when its inclination is reduced. The variations of descent slope that result therefrom necessarily are of no importance at this still high altitude where, as mentioned previously, no particular slope is required by the flight plan. It is the most economical guidance mode and the most comfortable, but also the least precise in terms of following the vertical profile.

Then, when the aircraft passes below a certain level of altitude, the vertical profile of the flight plan imposes altitudes and therefore changes of slope. It is then necessary not only to monitor the speed of the aircraft, but it is also necessary to monitor its altitude. For example, the aircraft may switch to Vpath/SPD guidance mode. The engine thrust fluctuates according to the speed instruction. It is a less economical and less comfortable guidance mode. But it is also extremely precise in terms of following the vertical profile and hence very suitable for the approach phase.

Outside this nominal case, many more or less unexpected situations may lead to degraded cases. For example, when the aircraft begins its descent at nominal speed in Vpath/THR mode, that is to say at fixed profile slope and thrust, it frequently happens that it is suddenly exposed to wind. During wind from behind, the aircraft accelerates beyond its nominal speed, which may temporarily go against safety and the observance of the time schedules. When it exceeds a ceiling speed, Vₘₐₓ, the aircraft must be slowed down. Compensating for the wind with thrust is not very effective because of the inertia of the jet engines: the effect of adjusting the thrust makes itself felt with a certain delay, whereas the wind is changeable by nature. Consequently, in Vpath/THR mode, it is necessary to compensate for the effects of the wind by acting on the elevator. To slow down the aircraft, it is therefore necessary to raise the aircraft nose, so the slope of descent reduces at the same time as it slows, until its speed stabilizes at Vₘₐₓ which is considered to be a safe speed. But secondly, it is necessary to bring the aircraft to its nominal speed which is the speed ensuring that the planned time schedule and/or speeds are complied with. To do this, the aircraft may for example switch to SPD/THR guidance mode, that is called “recovery mode”, by fixing the speed parameter at the nominal speed value. The aircraft slows down gradually until it returns to its nominal speed, while seeing its descent slope increase progressively. It is only on returning to its nominal speed that it returns to nominal guidance mode Vpath/THR. Similarly, in the case of a sudden headwind, the aircraft slows down suddenly and may go below a safe speed Vₘᵢₙ. It then switches to an appropriate recovery mode, to subsequently return to its nominal guidance mode Vpath/THR. And so on, the aircraft switches from one guidance mode to another in line with the unexpected operational situations with which it is confronted. These unexpected situations may cause its speed and/or its altitude to vary above maximum values or below minimum values, which makes it necessary every time to determine the new guidance mode that is most appropriate to the new situation and therefore to correct the trajectory of the aircraft. The aim is always to return to the nominal guidance mode Vpath/THR.

Typically, such an operational logic may be applied electronically by a state machine. This is what happens on commercial aircraft of the Airbus type. In this type of implementation, each guidance mode is a state of the state machine. The change of speed and/or altitude above a maximum value or below a minimum value is an event of the state machine. Unfortunately, converging towards the nominal state Vpath/THR in such an unpredictable environment is very often difficult, since a new unexpected situation frequently occurs to disrupt the descent of the aircraft when it is still in a recovery state. Therefore, in many cases, it is necessary to introduce intermediate states making it possible to switch indirectly from one state to another. These intermediate states are often used for a very short time, which even mechanisms for confirming change of state events cannot avoid, such as waiting for a certain period after a maximum value has been exceeded in order to see if the trend is confirmed. Phenomena of alternating transitions between two states may even occur. In other words, the state machine is not very stable. Operationally, it nevertheless gives satisfactory results when it has been finely tuned for a given model of aircraft, particularly when the values of the change-of-state confirmers are well adjusted, whether in terms of times or in terms of speed and/or altitude margins. But this requires a long phase of fine-tuning on the ground and in flight, the in-flight tests furthermore requiring dedicated means of communication with the ground to analyse the results and simulate correction scenarios. Since this complex and costly fine-tuning has to be applied for each aircraft model, the current solution therefore has major economic disadvantages.

### SUMMARY OF THE INVENTION

The main object of the invention is to alleviate the aforementioned disadvantages by systematically taking account of the speed constraints in order to adjust the parameter of inclination about the pitch axis, irrespective of the guidance mode. This has the effect of limiting the changes of modes. If it is implemented in the form of a state machine, the invention leads to a state machine in which the unstable intermediate states are even no longer reached and may be deleted. Accordingly, the subject of the invention is a method used by an aircraft to follow a descent trajectory matched with a time schedule, characterized in that the speed of the aircraft is servo-controlled to the speed required to comply with the time schedule. The pitch angle is adjusted when the aircraft is not below the planned altitude on the trajectory beyond a threshold. The engine thrust is adjusted when the aircraft is below the planned altitude on the trajectory beyond the threshold.

Advantageously, the speed required for complying with the time schedule may be a speed instruction lying between the minimum speed and the maximum speed of the aircraft, computed in order to comply with time constraints and/or speed constraints originating from a flight plan followed by the aircraft. The planned altitude on the trajectory may for its part be deduced from a vertical profile segment extracted from this flight plan.

When the aircraft is not below the planned altitude on the trajectory beyond the threshold, the adjustment of the pitch angle may be made at constant speed and at constant engine thrust.

When the aircraft is below the planned altitude on the trajectory but not beyond the threshold, the speed may be fixed substantially at the speed required to comply with the time schedule and the engine thrust may be fixed slightly above the cruising rate.

When the aircraft is above the planned altitude on the trajectory but not beyond a second threshold, the speed may be fixed substantially at the speed required to comply with the time schedule and the engine thrust may be fixed at the cruising rate.

When the aircraft is above the planned altitude on the trajectory beyond the second threshold, the speed may be fixed at a value slightly above the speed required to comply with the time schedule and the engine thrust may be fixed at the cruising rate.

For example, the pitch angle may be adjusted by acting on the elevator of the aircraft.

When the aircraft is below the planned altitude on the trajectory beyond the threshold, the adjustment of the engine thrust may be made at constant speed and following of the profile segment may be servo-controlled by a pitch command.

When the aircraft is below the planned altitude on the trajectory beyond the threshold, the speed may be fixed at a value slightly below the speed required to comply with the time schedule and the pitch angle may be servo-controlled at a value making it possible to get back onto the trajectory with a constant vertical speed. For example, the pitch angle may be fixed at a value making it possible to get back onto the trajectory with a vertical speed of descent fixed at −1000 feet per minute for example.

When the aircraft is below the planned altitude on the trajectory beyond the threshold, the speed may be fixed substantially at the speed required to comply with the time schedule and the pitch angle may be servo-controlled at a value making it possible to get back onto the trajectory at a constant load factor by following a parabolic path tangential to the trajectory.

For example, the engine thrust may be adjusted by acting on the throttle of the aircraft.

A further subject of the invention is a system used by an aircraft to follow a descent trajectory matched with a time schedule. A state machine implements the method according to any one of the preceding claims, each state of the state machine (40, 41, 42, 43, 44) corresponding to a pair of fixed navigation parameters taken from the speed, the pitch angle and the engine thrust. The events triggering the transitions of the state machine correspond to passing the planned altitude on the trajectory or passing the altitude below the planned altitude on the trajectory corresponding to the first threshold or passing the altitude above the planned altitude on the trajectory corresponding to the second threshold.

Further main advantages of the invention are that it makes it possible to more quickly stabilize the speed of the aircraft and therefore no longer exceed the safety speeds in descent, while this is often the case when the elevator is actuated as a priority for descending, the speed controlled by the automatic throttle usually being less responsive. Therefore, the invention makes it possible to revise upwards the maximum safety speeds, since there is much less risk of exceeding them. The result of this is generally a better management of aircraft speed during the descent phase, with less application of throttle and therefore a substantial reduction in the consumption of kerosene. In addition, the invention makes it possible to maximize the use of the engines at their cruising rate, thereby minimizing the wear on the aircraft and optimizing the comfort of the passengers. It should also be noted that the invention, by giving priority to control of the speed, makes it possible more easily to comply with the time constraints that are increasingly strict in civil air traffic control. Airlines and passengers, but also air traffic management and even the environment, all those involved in air traffic, have an interest in the invention.

### BRIEF DESCRIPTION OF THE DRAWINGS

Other features and advantages of the invention will emerge with the aid of the following description made with respect to the appended drawings which show:

FIG. 1, an illustration via a diagram of the vertical flight profile in descent of an aircraft and an exemplary state machine according to the prior art making it possible to follow this profile;

FIG. 2, an illustration via a diagram of the same vertical flight profile in descent and an exemplary state machine using the method according to the invention and making it possible to follow this profile;

FIG. 3, an illustration of an exemplary system architecture applying the method according to the invention.

### DETAILED DESCRIPTION OF THE DRAWINGS

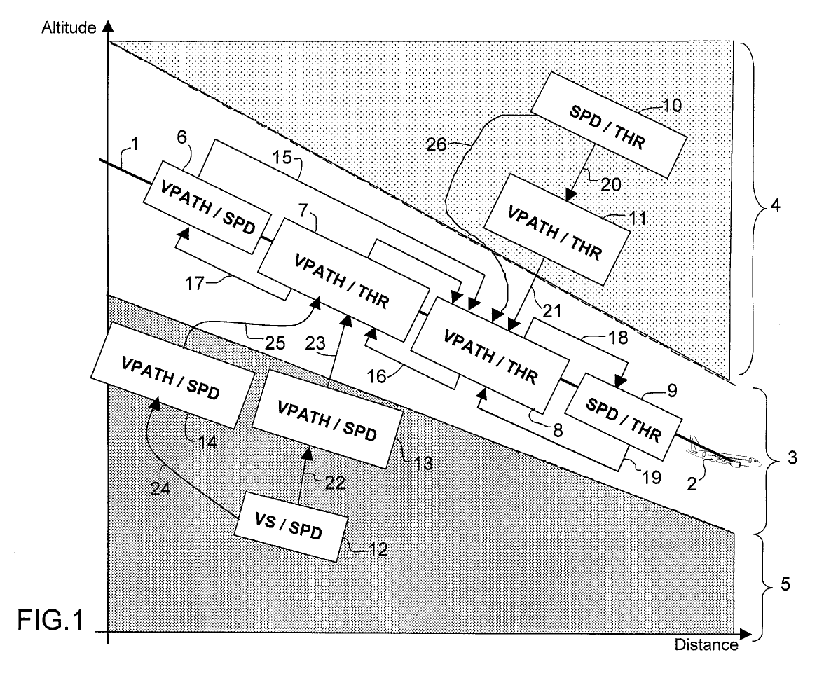

FIG. 1 illustrates via a diagram the vertical flight profile in descent of an aircraft and the states and transitions of an exemplary state machine according to the prior art making it possible for the aircraft to follow this profile.

A trajectory 1 of an aircraft 2 in the descent phase is shown in a system of axes where the abscissa represents the distance to the ground and the ordinate represents the altitude. The trajectory 1 is extracted from the flight profile imposed in the flight plan followed by the aircraft 2. For example the aircraft 2 is descending to land, so it is following an air route for an airport approach. A zone 3 encompasses the air space around the trajectory 1; it is called the “capture zone” of the flight profile. It is in the zone 3 that the aircraft, if it has left its planned trajectory 1, is likely to “recapture” this trajectory 1, in the sense of complying with it again. The zone 3 may be a tube in 3D whose diameter reduces when the altitude reduces. Specifically, the more the aircraft 2 descends and approaches the airport, the more the constraints associated with air traffic density are important and the less maneuvering margin the aircraft 2 has. This is to guarantee that there is no collision with the other aircraft using the same airport. A zone 4 encompasses all the air space situated above the zone 3. In the zone 4, the aircraft 2 must take measures to descend more quickly in order to comply with the trajectory 1. A zone 5 encompasses all the air space situated beneath the zone 3. In the zone 5, the aircraft 2 must take measures to descend less quickly in order to comply with the trajectory 1.

States 6, 7, 8 and 9 allow the aircraft 2 to follow the descent trajectory 1 relatively precisely in the nominal case in which no unexpected situation occurs. The state 6 corresponds to the guidance mode Vpath/SPD. The state 7 corresponds to the guidance mode Vpath/THR with the thrust fixed slightly above the cruising rate. The state 8 also corresponds to the guidance mode Vpath/THR, but with the thrust fixed at cruising rate. The state 9 corresponds to the guidance mode SPD/THR. From now onwards, a state will be qualified by the guidance mode to which it corresponds. For example, the states 7 and 8 will be respectively called “state 7 Vpath/THR” and “state 8 Vpath/THR”. In FIG. 1, transitions are also shown by arrows. A transition is the switch from one state to another when a condition is achieved. In the state machines according to the prior art like that illustrated by FIG. 1, the condition is always associated with passing a speed threshold and sometimes also associated with passing an altitude threshold. Therefore, a transition 15 makes it possible to switch from the state 6 Vpath/SPD to the state 8 Vpath/THR. A transition 16 makes it possible to switch from the state 8 in which the thrust is fixed at cruising rate to the state 7 in which the thrust is fixed slightly above cruising rate. A transition 17 makes it possible to switch from the state 7 Vpath/THR to the state 6 Vpath/SPD. A transition 18 makes it possible to switch from the state 8 Vpath/THR to the state 9 SPD/THR. A transition 19 makes it possible to switch from the state 9 SPD/THR to the state 8 Vpath/THR.

States 10 and 11 allow the aircraft 2 to return to the descent trajectory 1 when it is in the zone 4. In this case, the aircraft 2 has left the flight profile in the upwards direction following an unexpected situation that has prevented it from descending quickly enough. The state 10 corresponds to the guidance mode SPD/THR. The state 11 corresponds to the guidance mode Vpath/THR, an unstable intermediate state. A transition 20 makes it possible to switch from the state 10 SPD/THR to the state 11 Vpath/THR. A transition 21 makes it possible to switch from the state 11 Vpath/THR with the pitch angle fixed at a value greater than the slope of the flight profile to the state 8 Vpath/THR with the pitch angle fixed at the slope of the flight profile. A transition 26 makes it possible to switch from the state 10 SPD/THR to the state 8 Vpath/THR.

States 12, 13 and 14 allow the aircraft 2 to return to the descent trajectory 1 when it is in the zone 5. In this case, the aircraft 2 has left the flight profile in the downwards direction following an unexpected situation that has forced it to descend too quickly. The state 12 corresponds to the guidance mode VS/SPD. The state 13 corresponds to the guidance mode Vpath/SPD, an unstable intermediate state. The state 14 also corresponds to the guidance mode Vpath/SPD, also an unstable intermediate state. A transition 22 makes it possible to switch from the state 12 VS/SPD to the state 13 Vpath/SPD. A transition 23 makes it possible to switch from the state 13 Vpath/SPD to the state 7 Vpath/THR. A transition 24 makes it possible to switch from the state 12 VS/SPD to the state 14 Vpath/SPD. A transition 25 makes it possible to switch from the state 14 Vpath/SPD to the state 7 Vpath/THR.

As mentioned above, it appears that the guidance mode Vpath/THR is indeed the preferred guidance mode to which all the transitions of the state machine illustrated by FIG. 1 tend to return directly or indirectly. It is an extremely complex state machine with 9 states and 13 transitions, comprising intermediate states as defined above and using submodes. Three submodes Vpath/SPD are represented by the states 6, 13 and 14. Three submodes Vpath/THR are represented by the states 7, 8 and 11. Two submodes SPD/THR are represented by the states 9 and 10. The intermediate states are the states 11, 13 and 14. Used for a very short period, change-of-state confirmers tend to limit the phenomena of transitions alternating with these intermediate states. However, the unnecessary “blinking” phenomena of these states remain inevitable and the state machine remains relatively unstable. It should be noted that the fine-tuning of these confirmers is extremely costly since it requires deploying considerable communication and simulation means for each type of aircraft.

In the exemplary state machine according to the prior art shown by FIG. 1, the aircraft 2 virtually perfectly follows the altitude of the trajectory 1 in the nominal case. It is clearly altitude control that is preferred to the detriment of speed control. The speed is corrected actively only if it exceeds the minimum safety limit or maximum safety limit, systematically triggering a transition and a change of state.

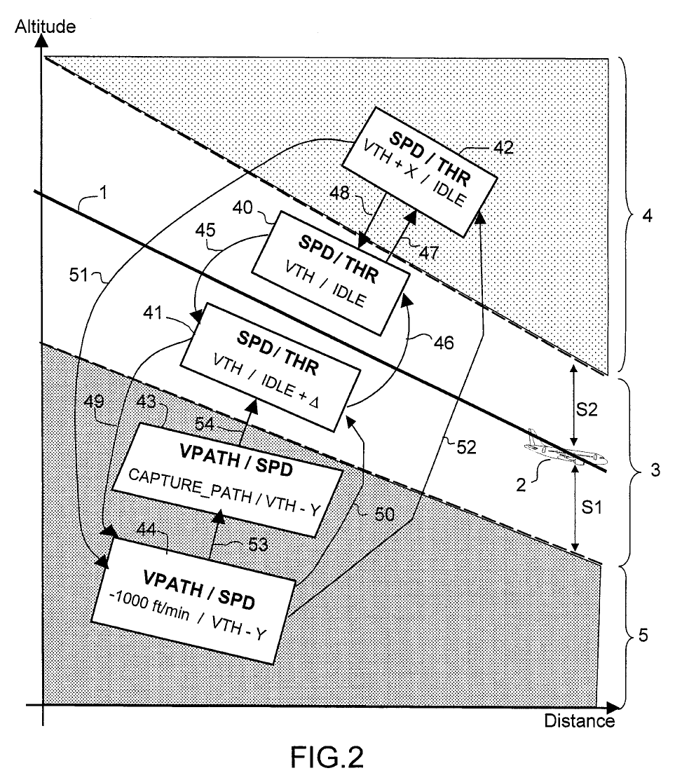

FIG. 2 illustrates via a diagram the same vertical flight profile in descent as FIG. 1 and the states and transitions of an exemplary state machine using the method according to the invention and making it possible for the aircraft to follow this profile. It is important to emphasize that a state machine is an advantageous way of implementing the method according to the invention, particularly in the existing systems, but the latter may be implemented in other ways.

The aircraft 2 in the descent phase following the trajectory 1 is represented in the same system of axes as in FIG. 1. The trajectory 1 may for example be deduced from the flight plan followed by the aircraft 2. The same zones 3, 4 and 5 are also represented. Particularly the zone 3 may be defined by two altitude thresholds S1 and S2, respectively below and above the planned altitude on the trajectory 1. Advantageously, the values of the altitude thresholds S1 and S2 may diminish when the planned altitude on the trajectory diminishes. Therefore, the zone 3 may be a tube in 3D whose diameter diminishes when the altitude diminishes.

States 40 and 41 allow the aircraft 2 to remain in the zone 3 around the trajectory 1. They both correspond to the guidance mode SPD/THR. Advantageously, in the state 40, the speed may be fixed at the theoretical speed to comply with the time schedule, marked V_{TH}, and the thrust may be fixed at the cruising rate, marked IDLE. Also advantageously, in the state 41, the speed may be fixed at the same theoretical speed V_{TH}, but the thrust may be fixed slightly above the cruising rate, a rate marked IDLE+Δ. The theoretical speed V_{TH} may for example be deduced from the flight plan followed by the aircraft 2. In the state machines according to the invention like that illustrated by FIG. 2, the conditions of transition are always associated with passing an altitude threshold and never with passing a speed threshold. Therefore, a transition 45 makes it possible to switch from the state 40 SPD/THR at the cruising rate IDLE to the state 41 SPD/THR slightly above the cruising rate IDLE+Δ, provided that the aircraft 2 passes below the trajectory 1. Conversely, a transition 46 makes it possible to switch from the state 41 SPD/THR slightly above the cruising rate IDLE+Δ to the state 40 SPD/THR at the cruising rate IDLE, provided that the aircraft 2 passes above the trajectory 1.

When the aircraft 2 is in the zone 3 above the trajectory 1 in mode 40 SPD/THR and provided that it leaves the zone 3 in the upwards direction entering the zone 4, a transition 47 to a state 42 SPD/THR is triggered. Advantageously, in the state 42 the speed may be fixed slightly above the theoretical speed, marked V_{TH}+X, and the thrust may be fixed at the cruising rate IDLE. Two possibilities then arise. The first possibility is that a transition 48 for a direct return to the state 40 SPD/THR is triggered, provided that the aircraft 2 returns to the zone 3 of flight profile capture. The second possibility is an exceptional case that will be explained below.

When the aircraft 2 is in the zone 3 below the trajectory 1 in mode 41 SPD/THR and provided that it leaves the zone 3 in the downwards direction entering the zone 5, a transition 49 to a state 44 Vpath/SPD is triggered. Advantageously, in the state 44 the speed may be fixed slightly below the theoretical speed, marked V_{TH}−Y, and the inclination about the pitch axis may be calculated so as to correspond to a vertical speed of −1000 feet per minute taking account of the speed. Three possibilities then arise. The first possibility is that the aircraft 2 directly returns to the zone 3, thereby triggering a transition 50 for direct return to the state 41 SPD/THR. The second possibility is that, initially, the aircraft 2 resumes the conditions necessary for returning to the zone 3 and particularly retakes control of its speed. This then triggers a transition 53 from the state 44 Vpath/SPD to a state 43 Vpath/SPD. Advantageously, in the state 43 the speed may be fixed at the theoretical speed V_{TH} and the pitch angle may be fixed so as to return to the capture zone 3 at a constant load factor and along a parabolic trajectory tangential to the trajectory 1, marked CAPTURE_PATH. And secondly only, the aircraft 2 returns to the zone 3 triggering a transition 54 from the state 43 Vpath/SPD to the state 41 SPD/THR. The third possibility is an exceptional case in which a direct transition 52 from the state 44 Vpath/SPD to the state 42 SPD/THR is triggered, provided that the altitude of the aircraft 2 increases sharply, causing it to move very rapidly from the zone 5 to the zone 4. And conversely, the exceptional case mentioned above may occur when the aircraft 2 is in the zone 4 at the state 42 SPD/THR; a transition 51 for a direct return to the state 44 Vpath/SPD may be triggered, provided that the altitude of the aircraft 2 falls sharply, causing it to move very rapidly from the zone 4 to the zone 5.

In the exemplary state machine according to the invention presented by FIG. 2 and unlike the exemplary state machine according to the prior art presented by FIG. 1, the aircraft 2 does not closely follow the altitude of the trajectory 1 in the nominal case. The aircraft 2 keeps itself only in the 3D tube defined by the zone 3 around the trajectory 1. It is clearly speed control that is preferred to the detriment of altitude control. Specifically, over the whole descent, the speed of the aircraft 2 is more or less maintained at the theoretical speed V_{TH}, varying between V_{TH}+X and V_{TH}−Y, the theoretical speed being that with which the vertical profile of the flight plan, from which the trajectory 1 is extracted, has been generated. The theoretical speed V_{TH} is the speed most likely to ensure that the time schedule is complied with. This makes it possible indirectly to control the altitude of the aircraft 2, since, at constant thrust, following a speed profile means following an altitude profile. The altitude is corrected actively only if it passes the safety floor or ceiling materialized by the zone 3, triggering a transition and a change of state.

The speed can be controlled on the one hand thanks to the elevator when the aircraft is in the zone 3 or above the zone 3 and is flying in the guidance mode SPD/THR corresponding to the states 40, 41 and 42. Specifically, as explained above, the elevator is more precise and more responsive than the throttle, not requiring confirmers and/or considerable margins around minimum and maximum speed values to compensate for a possible inertia effect.

The speed may be controlled on the other hand thanks to the throttle when the aircraft is beneath the zone 3 and flying in the guidance mode Vpath/SPD corresponding to the states 43 and 44. A floating instruction in inclination about the pitch axis may initially cause the aircraft 2 to converge towards the trajectory 1, this floating instruction corresponding permanently to a vertical speed of −1000 feet per minute. It is the state 44. Then, possibly secondly, the instruction of inclination about the pitch axis may cause the aircraft 2 to converge towards the trajectory 1 following a parabolic trajectory tangential to the trajectory 1 at a constant load factor. It is the state 43.

By comparison with FIG. 1, FIG. 2 shows a marked simplification when the invention is implemented in the form of a state machine, changing from 9 states to 4 or 5 states only and from 13 to 8 transitions. In particular, the states corresponding to the modes VS/SPD and Vpath/THR disappear which makes the state machine much more stable. The gains thus achieved in fine-tuning are considerable.

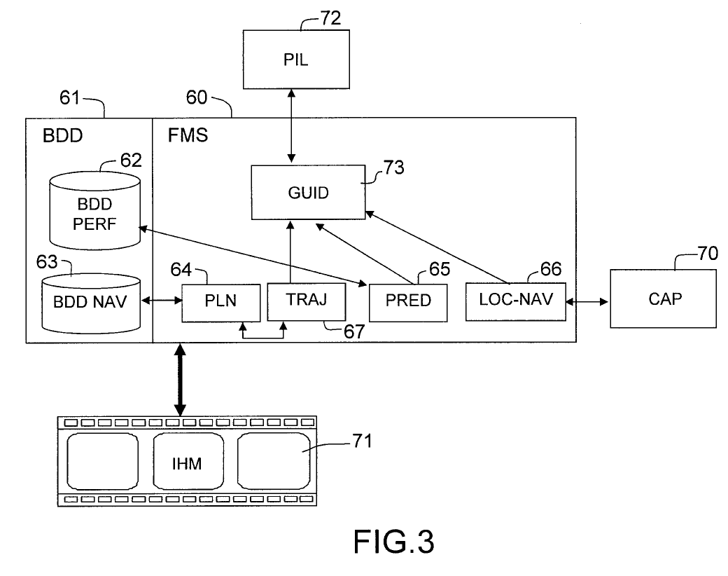

FIG. 3 illustrates via a diagram an exemplary system architecture making it possible to apply the method according to the invention within an FMS system 60. A guidance module 73 implements the method according to the invention, for example by a state machine as described above. A trajectory-determination module 67 supplies the module 73 with the vertical descent profile of the flight plan that the aircraft must follow. For example, it may be the trajectory 1 of the preceding figures. The module 67 receives the flight plan from a flight plan management module 64, the module 64 converting the aviation beacons describing the flight plan thanks to a navigation database 63. A location and navigation module 66 supplies the module 73 with the instantaneous kinematic characteristics of the aircraft in terms of position, altitude, speed, pitch and roll. The module 66 itself receives the raw data from a module 70 combining sensors of the satellite positioning beacon and/or central inertial type. A prediction module 65 supplies the module 73 with the predicted times of passage at the points marking the trajectory to be followed, these points determining the time schedule, and the predicted points of change of kinematics. To perform its calculations, the module 65 receives the performance of the aircraft from a database 62.

Based on the vertical profile to be followed supplied by the module 67, the time schedule supplied by the module 65 via the predicted times of passage at the points and based on the instantaneous kinematic characteristics of the aircraft supplied by the module 66, the module 73 determines the guidance instructions that are the most suitable for the aircraft to follow the vertical profile, by applying the method according to the invention described above. For example, the module 73 may implement a state machine. The guidance instructions may be supplied to a pilot module 72 for automatic application. If necessary, the instructions may also be displayed on a man-machine interface module 71 for manual application of the instructions.

The invention described above makes it possible in particular to simplify the operational logic by greatly reducing the number of guidance modes and submodes. Being more robust, the operational logic is easier to adjust and test. In particular, in the case of an implementation by a state machine, the unstable intermediate states are no longer necessary and may therefore be deleted. The state machine is thereby greatly simplified. The change-of-state confirmers, sources of lengthy and costly adjustments depending on the aircraft model, are also unnecessary. The invention therefore leads to a state machine that is simple because it has few states, these states being stable and the state machine being able to be used for all aircraft models. The gain in fine-tuning is considerable.

Finally, preferring a precise maintenance of speed from the top of the descent makes it possible for the user not to find himself having subsequently to handle a problem of too much or not enough energy, the energy in question consisting of the speed through kinetic energy and of the altitude through potential energy.

1. Method used by an aircraft to follow a descent trajectory matched with a time schedule, wherein the speed of the aircraft is servo-controlled to the speed required to comply with the time schedule comprising the steps of:
adjusting the pitch angle when the aircraft is not below the planned altitude on the trajectory beyond a threshold;
adjusting the engine thrust when the aircraft is below the planned altitude on the trajectory beyond the threshold.

2. The method according to claim 1, wherein the speed required for complying with the time schedule is a speed instruction lying between the minimum speed and the maximum speed of the aircraft, computed in order to comply with time constraints and/or speed constraints originating from a flight plan followed by the aircraft.

3. The method according to claim 1, wherein the planned altitude on the trajectory is deduced from a vertical profile segment extracted from a flight plan followed by the aircraft.

4. The method according to claim 1, wherein, when the aircraft is not below the planned altitude on the trajectory beyond the threshold, the adjustment of the pitch angle is made at constant speed and at constant engine thrust.

5. The method according to claim 2, wherein, when the aircraft is below the planned altitude on the trajectory but not beyond the threshold, the speed is fixed substantially at the speed required to comply with the time schedule and the engine thrust is fixed slightly above the cruising rate.

6. The method according to claim 3, wherein, when the aircraft is above the planned altitude on the trajectory but not beyond a second threshold, the speed is fixed substantially at the speed required to comply with the time schedule and the engine thrust is fixed at the cruising rate.

7. The method according to claim 4, wherein, when the aircraft is above the planned altitude on the trajectory beyond the second threshold, the speed is fixed at a value slightly above the speed required to comply with the time schedule and the engine thrust is fixed at the cruising rate.

8. The method according to claim 1, wherein the pitch angle is adjusted by acting on the elevator of the aircraft.

9. The method according to claim 3, wherein, when the aircraft is below the planned altitude on the trajectory beyond the threshold, the adjustment of the engine thrust is made at constant speed and following of the profile segment is servo-controlled by a pitch command.

10. The method according to claim 7, wherein, when the aircraft is below the planned altitude on the trajectory beyond the threshold, the speed is fixed at a value slightly below the speed required to comply with the time schedule and the pitch angle is servo-controlled at a value making it possible to get back onto the trajectory with a constant vertical speed.

11. The method according to claim 10, wherein the pitch angle is fixed at a value making it possible to get back onto the trajectory with a fixed vertical speed of descent.

12. The method according to claim 7, wherein, when the aircraft is below the planned altitude on the trajectory beyond the threshold, the speed is fixed substantially at the speed required to comply with the time schedule and the pitch angle is servo-controlled at a value making it possible to get back onto the trajectory at a constant load factor by following a parabolic path tangential to the trajectory.

13. The method according to claim 1, wherein the engine thrust is adjusted by acting on the throttle of the aircraft.

14. The system used by an aircraft to follow a descent trajectory matched with a time schedule, wherein it implements via a state machine the method according to claim 1, each state of the state machine corresponding to a pair of fixed navigation parameters taken from the speed, the pitch angle and the engine thrust, the events triggering the transitions of the state machine corresponding to passing the planned altitude on the trajectory or passing the altitude below the planned altitude on the trajectory corresponding to the first threshold or passing the altitude above the planned altitude on the trajectory corresponding to the second threshold.

15. The system of claim 14, wherein the speed required for complying with the time schedule is a speed instruction lying between the minimum speed and the maximum speed of the aircraft, computed in order to comply with time constraints and/or speed constraints originating from a flight plan followed by the aircraft.

16. The system of claim 14, wherein the planned altitude on the trajectory is deduced from a vertical profile segment extracted from a flight plan followed by the aircraft.

17. The system of claim 14, wherein, when the aircraft is not below the planned altitude on the trajectory beyond the threshold, the adjustment of the pitch angle is made at constant speed and at constant engine thrust.

18. The system of claim 15, wherein, when the aircraft is below the planned altitude on the trajectory but not beyond the threshold, the speed is fixed substantially at the speed required to comply with the time schedule and the engine thrust is fixed slightly above the cruising rate.

19. The system of claim 16, wherein, when the aircraft is above the planned altitude on the trajectory but not beyond a second threshold, the speed is fixed substantially at the speed required to comply with the time schedule and the engine thrust is fixed at the cruising rate.

20. The system of claim 17, wherein, when the aircraft is above the planned altitude on the trajectory beyond the second threshold, the speed is fixed at a value slightly above the speed required to comply with the time schedule and the engine thrust is fixed at the cruising rate.
